(19) United States
(12) Patent Application Publication
(10) Pub. No.: US 2010/0216908 A1
(43) Pub. Date: Aug. 26, 2010

(54) Antimicrobial Polymer Nanocomposites

(75) Inventors: Fengge Gao, Bedfordshire (GB); Rinat Nigmatullin, Nottinghamshire (GB)

Correspondence Address: YOUNG BASILE, 3001 WEST BIG BEAVER ROAD, SUITE 624, TROY, MI, 48084, US

(73) Assignee: NOTTINGHAM TRENT UNIVERSITY, Nottinghamshire (GB)

(21) Appl. No.: 12/663,929

(22) PCT Filed: Jun. 10, 2008
(86) PCT No.: PCT/GB08/50426

§ 371 Date: Dec. 10, 2009

(30) Foreign Application Priority Data
Jun. 12, 2007 (GB) 0711188.3

(51) Int. Cl. C08K 3/34

(52) U.S. Cl. 523/122

(57) ABSTRACT

A method of preparing a polymer nanocomposite having antimicrobial properties, comprises (i) contacting a polymeric antimicrobial agent with a clay to form an organoclay; and (ii) subsequently dispersing the organoclay in a polymeric matrix. Polymer nanocomposites prepared by the method of the invention are not prone to leaching of the polymeric antimicrobial agent from the composite, and have many applications.

The present invention relates to polymer nanocomposites, and in particular to clay-polymer nanocomposites exhibiting antimicrobial properties and little or no leaching of the antimicrobial components of the nanocomposite. The invention extends to novel methods for preparing such antimicrobial nanocomposites, and to the use of such composites in various antimicrobial applications.

Currently, antimicrobial polymers are produced by either a so-called additive method, which involves adding inorganic or organic antimicrobial agents (biocides) into polymers, or by chemically bonding biocidal moieties onto a polymer structure. However, problems with the additive approach include poor compatibility between many biocides and the majority of polymers, and a decrease in mechanical properties and other important physical and engineering properties of the resultant polymer. Another significant problem is leaching of biocide from the polymer, and the resultant environmental and health risk due to leached biocides, such as heavy metals. This leaching also leads to a gradual loss of antimicrobial activity with complete loss of the activity once the biocide is exhausted from the polymer.

In principle, chemical bonding of biocides onto a polymer structure should overcome these problems. However, in practice, this approach often results in a loss in antimicrobial activity of the biocide after its immobilization on the polymer.

There is a significant need for improved materials with antimicrobial properties, for example, in hospitals where the risk of microbial infection (eg MRSA) is a concern. In addition, the clothing and defence industries require improved fabrics to combat microbial infections. Likewise, many common consumer items, including electronic devices such as mobile telephones, are prone to bacterial contamination. Furthermore, the food packaging industry is always seeking improved plastics which may be used to package food, for example plastics which prevent bacterial infection.

Earlier disclosures include the following:

WO-A-2006/136397 discloses the use of conventional clay/polymer nanocomposite technology with ammonium salts to produce nanocomposites with antimicrobial behaviour. However, the ammonium salts that are used are small molecules that are not polymeric in nature.

CN-A-1789312 is concerned with the use of clay to enhance the antimicrobial action of chitosan.

A method to produce antimicrobial clay/polymer nanocomposites by intercalating silver into clays is described in CN-A-1970643.

CN-A-1781983 describes a method for producing an antimicrobial clay/polymer nanocomposite by the copolymerisation of acrylonitrile and polymerisable quaternary ammonium salts.

However, none of these earlier disclosures provides an antimicrobial clay/polymer nanocomposite with entirely satisfactory properties.

It is therefore an object of the present invention to overcome or mitigate one or more of the problems of the prior art, whether identified herein or elsewhere, and to provide new polymer nanocomposites, which exhibit improved antimicrobial properties and/or reduced leaching of biocidal components, and to provide methods for preparing such composites. A further aim of the invention is to provide novel uses of such nanocomposites.

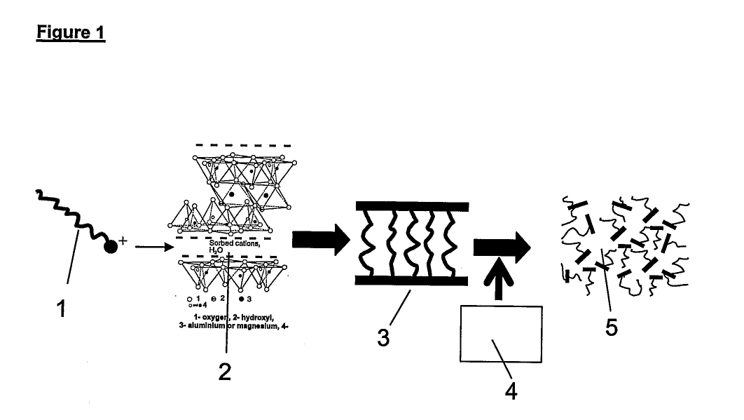

The inventors have devised a novel method for producing antimicrobial polymer nanocomposites based on inorganic particulate clay/polymer nanocomposite technology. FIG. 1 schematically represents the new method, which involves intercalating a polymeric antimicrobial agent (or biocide) in a clay to form an organoclay, and then dispersing the resultant organoclay in a polymeric matrix to form a polymer-clay nanocomposite material. The nanocomposite material has antimicrobial properties due to the presence of the biocide compound, and leaching of the biocide from the nanocomposite is reduced or eliminated, due (it is presently believed) to the polymeric nature of the biocide compound.

Hence, according to a first aspect of the invention, there is provided a method of preparing a polymer nanocomposite having antimicrobial properties, the method comprising:

(i) contacting a polymeric antimicrobial agent with a clay to form an organoclay; and

(ii) subsequently dispersing the organoclay in a polymeric matrix.

By the term “nanocomposite”, we mean a polymeric material containing a filler with at least one dimension in the nanometre range. In the present invention, the filler is clay.

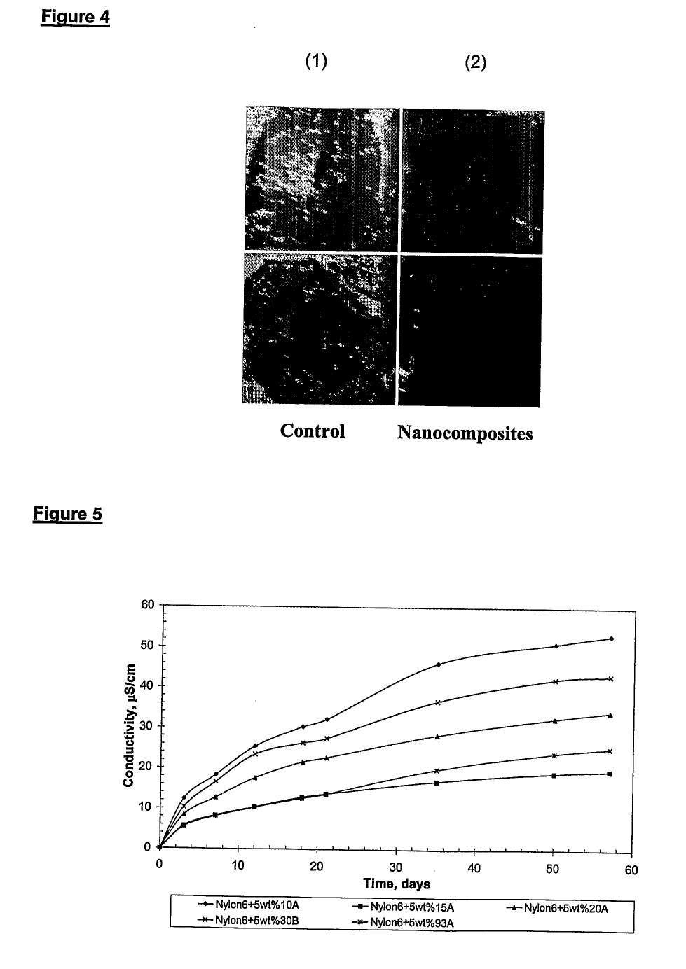

Nanocomposites obtained using conventional clay/polymer nanocomposite technology may have antimicrobial properties, but may suffer from the disadvantage of leaching or migration of the biocide from the nanocomposite. The experimental results discussed below in relation to FIG. 5 illustrate the problem of biocide leaching when conventional non-polymeric biocides are employed. The present invention overcomes this problem by intercalating clay with non-migrating polymeric biocides. It is believed that the avoidance of biocide leaching is attributable to the polymeric nature of the biocide. This avoids not only environmental and health problems due to a leached biocide, but also means there is little or no decrease in biocide activity over time.

Step (i) of the method of the invention involves contacting the polymeric antimicrobial agent with clay.

It will be understood by those skilled in the art that the term “clay” refers to natural aluminosilicates. Clays have layers of linked (Al, Si)O₄ tetrahedra combined with layers of Mg(OH)₂ or Al(OH)₃.

The clay may be selected from a group of clay types including smectite, illite and chlorite.

Suitable smectite clays that may be used in the invention include montmorillonite, bentonite, nontronite, beidellite, volkonskoite, hectorite, sapanite, stevensite, sauconite, sobockite and svinfordite. Suitable smectite clays have the general chemical composition

XSi₈Y₄O₂₀(OH)₄

in which X represents an interlayer site, and in which Y is Al, Mg, Cr, Ca, Mn or Li. By the term “interlayer site”, we mean water and cations, such as Na⁺, Ca²⁺, between the silicate layers.

Suitable illite clays include clay-micas. Suitable illites have the general chemical composition

YZ₂₋₃X₄O₂₀(OH)₄

in which X represents an interlayer site, and in which Y is Al, Mg, Cr, Ca, Mn or Li, and in which Z represents an element in a tetrahetral structure, for example Si.

The chlorite group of clays includes a wide variety of minerals with considerable chemical variation.

By the term “antimicrobial agent” and “biocide”, which are used interchangeably herein, we mean a substance that is capable of killing, inhibiting or slowing the growth of a microorganism. Examples of microorganisms against which the biocide or agent may be effective include bacteria, viruses, fungi, and protozoa.

By the term “polymeric antimicrobial agent”, we mean a polymer or copolymer with a molecular structure that contains functional groups with antimicrobial activity. The polymer may be a homopolymer, but is more commonly, and preferably, a copolymer. By appropriate variation of the proportions of the different monomer residues in the copolymer, the physical properties of the polymer may be optimised.

The polymeric antimicrobial agent is preferably ionic. This enables intercalation of the antimicrobial agent within the clay in step (i) of the method. It will be appreciated that the surface of the clay may be either positively charged, for example if the clay is a Double Layered Hydroxide (DLH), or negatively charged. for example if the clay is a smectite. Hence, in some embodiments, the antimicrobial agent may be anionic, for example when the clay with which it is contacted in step (i) has a positive surface charge.

However, in preferred embodiments, the antimicrobial agent is cationic, for example when the clay used in step (i) of the method has a negative surface charge. The antimicrobial agent may be a Lewis acid-type antimicrobial agent.

By the term “Lewis acid”, we mean an acid that has a tendency to accept a pair of electrons and form a coordinate covalent bond. Hence, when the antimicrobial agent is a Lewis acid-type, it is capable of interacting with a negatively charged species from the clay in step (i) of the method to thereby form the organoclay.

It is preferred that the clay surface has a net negative charge. This enables intercalation of a cationic antimicrobial agent upon contacting with the clay in step (i) of the method. Preferably, the clay is a smectite. Most preferably, the clay is montmorillonite. The general chemical formula of montmorillonite is

(Na,Ca)_{0.33}(Al, Mg)₂Si₄O₁₀(OH)₂.nH₂O.

Smectite clay, such as montmorillonite, has a 2:1 type layered-structure in which each silicate layer comprises two sheets of tetrahedral silica and one sheet of alumina. Such a structure is weak in a direction perpendicular to its plane due to weak van der Waals forces bonding between the layers, and strong in a direction parallel to its plane.

Preferably, a smectite clay is used in step (i) of the method of the invention. Natural smectite clay has a negative surface charge due to some of the aluminium cations Al³⁺ in the octagonal structure being substituted by lower valency cations such as Mg²⁺ and Ca²⁺.

Therefore, in a most preferred embodiment, the antimicrobial agent is cationic, and is incorporated into the interlayer spacing in the clay structure to form the organoclay in step (i) of the method. Since clay is hydrophilic and is therefore incompatible with most polymers, step (i) of the method preferably comprises using an ionic surfactant to convert the clay from a hydrophilic to an organophilic form.

By the term “organophilic”, we mean that the structure (of the clay) is in part hydrophilic and in part hydrophobic.

Most preferably, the method according to the invention involves the use of a polymeric antimicrobial agent that is also capable of acting as a surfactant, and is therefore capable of rendering the clay organophilic.

By the term “surfactant”, we mean an amphiphilic compound that contains both hydrophobic and hydrophilic regions in its molecular structure.

The hydrophobic region may for example comprise alkyl radicals or hydrophobic polymer segments. The hydrophilic region is preferably cationic.

Step (i) involves converting the clay into an antimicrobial organoclay by contacting the clay with the polymeric antimicrobial agent.

By the term “organoclay”, we mean a surfactant-modified clay, the surface properties of which are changed from hydrophilic to organophilic. Preferably, the polymeric antimicrobial agent used in step (i) comprises an onium group.

By the term “onium group”, we mean a cation derived by the protonation of mononuclear parent hydrides of elements of the nitrogen family (Group 15), chalcogen family (Group 16), or halogen family (Group 17), and similar cations derived by the substitution of hydrogen atoms in the former by other groups, such as organic radicals, or halogens, for example tetramethylammonium, and further derivatives having polyvalent additions, such as iminium and nitrilium. Such a cation may have the structure RₓA⁺. Suitable onium groups which may be used include ammonium, phosphonium, oxonium, chloronium, and sulphonium.

Antimicrobial agents used in step (i) may comprise quaternary ammonium groups attached to a polymer. The polymeric antimicrobial agent may be a random, block or grafted copolymer.

The polymeric antimicrobial agent may be a naturally occurring material, or a derivative thereof, but is more commonly, and preferably, a synthetic polymeric material.

The polymeric Lewis acid-type antimicrobial agent is preferably represented by formula I:

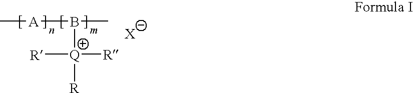

in which

n and m are independently between 2 and 500;

the groups A, which may be the same or different, are monomer residues of a first form;

the groups B, which may be the same or different, are monomer residues of a second form;

the group Q^{⊕}, is a nitrogen or phosphorous atom;

R, R′ and R″ independently represent hydrogen or an optionally substituted alkyl or aryl group; and

X⁻ is a counterion.

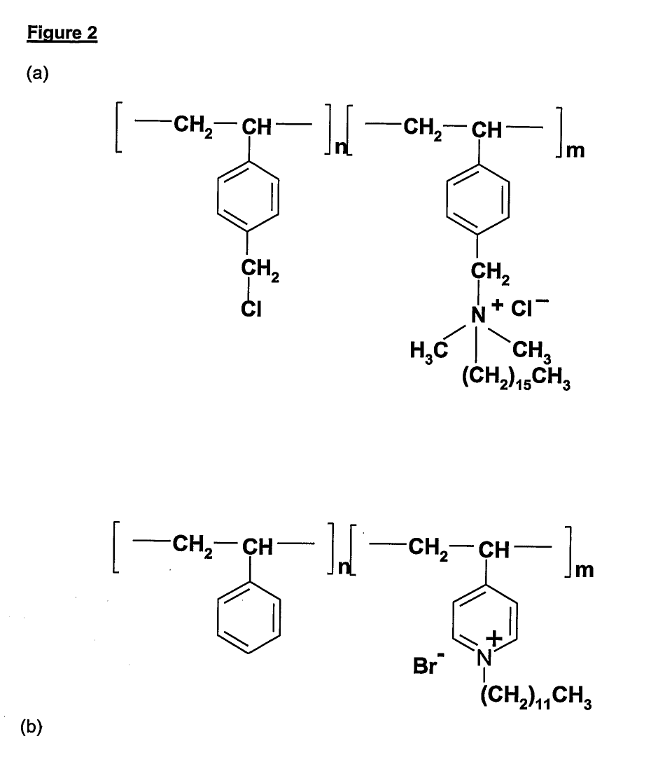

Examples of a suitable monomer residue (A) and (B) independently include optionally substituted alkylene groups. For example, where (A) or (B) represents an optionally substituted alkylene group, it may suitably be a C₁-C₅ alkylene group. For example, (A) and/or (B) may represent an ethylene group, and most preferably a substituted ethylene group, as illustrated in FIGS. 2a and 2b. Such polymers may be obtained by the polymerisation of a vinylic monomer, eg styrene and/or substituted derivatives or analogues thereof.

Where R, R′ and/or R″ represents an optionally substituted alkyl group, it is most preferably a C₁-C₃₀ alkyl group, and more suitably, a C₁-C₂₀ alkyl group.

R preferably represents an optionally substituted alkyl group, eg a C₁-C₃₀ alkyl group, more preferably C₃-C₃₀ alkyl group, more suitably a C₆-C₃₀ alkyl group, and most suitably a C₁₀-C₃₀ alkyl group.

Preferably, one or both of R′ and R″ is hydrogen or a C₁-C₃₀ alkyl group, and more suitably a C₁-C₁₀ alkyl group, more preferably a C₁-C₇ alkyl group, even more preferably a C₁-C₅ alkyl group, and most preferably a C₁-C₃ alkyl group.

Most preferably, R is a relatively lengthy alkyl group, eg a C₁₀-C₃₀ alkyl group, and R′ and R″, which may be the same or different, represent hydrogen or a relatively short alkyl group, eg a C₁-C₃ alkyl group. It is believed that at least one lengthy radical is required to provide biocidal action since shorter radicals are not able to penetrate bacterial cell membrane.

Where R, R′ and/or R″ are substituted, the substituents may be selected from a wide range, including without limitation alkyl, aryl, and acyl.

Most preferably, the group Q^{⊕} is attached to the polymer chain via a linking group that may be an alkylene, arylene or aralkylene group. The linking group constitutes a substituent on the monomer residue B, and is most preferably a phenylene or a phenylmethylene group.

Examples of a suitable counterion X⁻ include Br⁻ or Cl⁻.

In other embodiments, the polymeric antimicrobial agent may be represented by formula II:

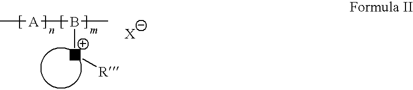

in which

n and m are independently between 2 and 500;

the groups A, which may be the same or different, are monomer residues of a first form;

the groups B, which may be the same or different, are monomer residues of a second form;

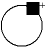

is a quaternary nitrogen-containing heterocycle;

R″′ represents hydrogen or an optionally substituted alkyl group; and

X⁻ is a counterion.

Where R″′ represents an optionally substituted alkyl group, it is preferably a C₃-C₃₀ alkyl group, more preferably a C₆-C₂₀ alkyl group, and most preferably a C₆-C₁₆ alkyl group.

Where R′″ is substituted, the substituents may be selected from a wide range, including without limitation alkyl, aryl, and acyl.

The quaternary nitrogen-containing heterocycle is most preferably a pyridyl group.

In Formulae I or II, n and m may be independently between 5 and 400, more suitably between 10 and 200, and most suitably between 20 and 100.

As used herein, and unless the context indicates otherwise, the following terms have the following meanings:

“Alkyl” means, unless otherwise specified, an aliphatic hydrocarbon group which may be straight or branched, and is optionally substituted.

“Acyl” means an H—CO— or alkyl-CO— group in which the alkyl group is as described above.

“Alkylene” means an aliphatic bivalent radical derived from a straight or branched alkyl group, in which the alkyl group is as described above. Exemplary alkylene radicals include methylene and ethylene.

“Aryl” as a group or part of a group denotes: (i) an optionally substituted monocyclic or multicyclic aromatic carbocyclic moiety of about 6 to about 14 carbon atoms, such as phenyl or naphthyl; or (ii) an optionally substituted aromatic monocyclic or multicyclic organic moiety of about 5 to about 10 ring members in which one or more of the ring members is/are element(s) other than carbon, for example nitrogen, oxygen or sulfur (ie a heterocyclic or heteroaryl moiety).

“Arylene” means an aromatic bivalent radical derived from an aryl group, in which the aryl group is as described above. Exemplary alkylene radicals include phenylene.

“Aralkylene” means a bivalent radical derived from an aryl and an alkyl group, in which the alkyl and aryl groups are as described above. Exemplary aralkylene radicals include phenylmethylene.

Where any group is described as “optionally substituted”, substituents that may be present include one or more of acyl, acylamino, alkoxy, alkoxycarbonyl, alkylenedioxy, alkylsulfinyl, alkylsulfonyl, alkylthio, aroyl, aroylamino, aryl, arylalkyloxy, arylalkyloxycarbonyl, arylalkylthio, aryloxy, aryloxycarbonyl, arylsulfinyl, arylsulfonyl, arylthio, carboxy, cyano, halo, heteroaroyl, heteroaryl, heteroarylalkyloxy, heteroaroylamino, heteroaryloxy, hydroxy, nitro, trifluoromethyl, amino and amido.

Polymeric antimicrobial agents of Formulae I and II are believed to be novel, and constitute a further aspect of the invention.

Preferably, the molecular weight of the polymeric antimicrobial agent is between 1,500 Da and 400,000 Da, more preferably between 5,000 Da and 150,000 Da, most preferably between 10,000 Da and 60,000 Da.

Preferably, the monomer unit (A) is selected to facilitate compatibility of the modified clay with the polymer in the polymer/clay nanocomposites. Preferably, the proportion of monomer units (B) in the polymeric antimicrobial agent is within the range 5 to 80 mol %, more preferably 7 to 65 mol %, and most preferably 10 to 50 mol %. Such concentrations restrict copolymer water solubility and improve miscibility of modified clays with the polymers contacted therewith in step (ii) of the method. Monomer unit (B) itself may not be hydrophilic. However, monomer unit (B) and its associated onium group together are preferably hydrophilic.

It is especially preferred that the polymeric antimicrobial agent comprises partially aminated polyvinylbenzylchloride (pVBzCl) or quaternised vinylpyridine-co-styrene (qVP-co-St), as illustrated in FIG. 2, in which n and m independently may be between 5 and 400, more suitably between 10 and 200, and most suitably between 20 and 100.

The method preferably comprises an initial step, before step (i), of preparing a clay suspension, for example, by contacting the clay with water. The suspension is preferably mixed at ambient temperature overnight. Hence, once the clay suspension and the antimicrobial agent (anionic or cationic) have been prepared, step (i) of the method may then be carried out.

Preferably, step (i) comprises contacting the antimicrobial agent with a clay suspension under constant mixing, preferably stirring. Preferably, the mixing is conducted at STP (21° C., 1 bar). Additional water may be added to improve mixing of the components.

Step (i) of the method may comprise at least one purification step in order to remove unbound biocidal polymer and isolated modified clay. The purification step may comprise centrifugation.

Step (i) may comprise a washing step, preferably, with a water/THF mixture in order to obtain the organoclay containing bound antimicrobial agent.

The organoclay produced in step (i) of the method is believed to be novel. Thus, in a further aspect of the invention, there is provided an organoclay comprising clay having intercalated therewith a polymeric antimicrobial agent. The polymeric antimicrobial agent may be of any of the forms discussed above. For example, it is preferably a synthetic polymeric material, and may have a structure represented by Formula I or Formula II.

Once the organoclay has been produced, step (ii) may then be carried out. Step (ii) of the method comprises dispersing the organoclay formed in step (i) in a suitable polymeric matrix to form an antimicrobial polymer-clay nanocomposite.

The polymer matrix preferably comprises synthetic polymer material, and may comprise a thermoset polymer, a thermoplastic polymer, or an elastomer polymer. For instance, the polymeric matrix may be selected from a group consisting of polyethylene; polypropylene; polystyrene; polyvinylchloride; polyamide (nylon); polyethyleneterephthalate; polybutyleneterephthalate; polymethylmethacrylate; polycarbonate; polyurethane; epoxy; polycaprolactone; polyvinylalcohol; acrylonitrile-butadiene-styrene; polyacrylonitrile; ethylene-vinylacetate; rubber; vulcanized rubber; polyimide; polyisoprene; polydimethylsiloxane; polysulphone, polyurethane; polyetheretherketone; polytetrafluoroethylene; polyvinylidenechloride; polyvinylidenefluoride; polyoxymethylene; polyethersulfone; poly(p-phenylene oxide); poly(p-phenylene sulfide); thermosetting polyesters; and cyanoacrylates.

Most preferably, the polymeric matrix is polyamide or polysulphone, as demonstrated in the Examples.

Step (ii) involves dispersing the organoclay in the polymer matrix to obtain the polymer nanocomposite. The advantage of using a polymeric antimicrobial agent therefore is that it reduces the risk or extent of biocide leaching. Although the inventors do not wish to be bound by any hypothesis, they postulate three possible reasons why biocide leaching does not occur from the nanocomposite of the invention. First, the polymeric antimicrobial agent may be insoluble in water. Secondly, the increased molecular weight of the polymeric antimicrobial agent may reduce the diffusion rate for leaching. Thirdly, cooperative interactions of the charged polymer biocide may occur with silicate layers in the clay, with the result that the polymer remains bound to the surface of the inorganic particles of the clay.

In one embodiment, step (ii) of the method may be carried out using melt processing techniques, such as screw extrusion and injection moulding. This method involves heating the polymeric matrix with the organoclay above the melt or glass transition temperature of the polymeric matrix, depending on whether the polymeric matrix is crystalline or amorphous. It will be appreciated that amorphous polymers do not have a melt temperature; they become soft above the glass transition temperature. However, crystalline polymers only melt above their melt temperature. Intercalation/exfoliation occurring in the polymer melt under shear stresses is introduced by the melt processing.

In another embodiment, step (ii) of the method may be carried out using in situ polymerization. In this embodiment, monomer precursor molecules of the polymeric matrix used in step (ii) are preferably inserted into the layer space in the organoclay. This step is preferably followed by further expanding and layer exfoliation within the matrix by polymerisation.

In an alternative embodiment, step (ii) of the method may be carried out using solvent-assisted dispersion. This embodiment involves using a suitable solvent to disperse the organoclay in the polymeric matrix. Intercalation of the polymeric matrix between the clay layers occurs during mixing of the polymeric matrix solvent solution containing dispersed organoclay.

By way of example, the polymer may be contacted with the organoclay (for example at about a 10:1 weight ratio) in dimethylacetamide (DMAA). The mixture may be mixed for 24 hours to provide uniform dispersion at STP. Once the mixing has been completed, the resultant composite may then be moulded or cast into any shape as desired. The composite is allowed to set by drying.

The end product of step (ii) of the method is a polymer-clay composite (or polymer nanocomposite). Preferably, the method of the invention involves preparing a polymer nanocomposite which comprises between about 0.1 and 30 wt % of organoclay modified with polymeric biocide. Preferably, the nanocomposite produced comprises between about 1 and 20 wt %, more preferably between about 2 and 10 wt %, and most preferably between about 2 and 6 wt % organoclay modified with polymeric biocide.

The composite may be moulded into any desired shape. The inventors believe that they are the first to prepare such antimicrobial polymer-clay nanocomposites.

Therefore, according to another aspect of the invention, there is provided an antimicrobial polymer nanocomposite obtainable by the method according to the first aspect of the invention.

According to a further aspect of the invention, there is provided an antimicrobial polymer nanocomposite comprising a clay, a polymeric antimicrobial agent, and a polymeric matrix.

The nanocomposites according to the second and third aspects of the invention have many advantages over known antimicrobial polymers. Most conventional techniques use silver and other metal particles as antimicrobial additives. These additives are expensive and incompatible with hydrophobic polymers in structure and properties. Therefore, their applications are limited. In contrast, polymer nanocomposites according to the present invention use clay, which is cheap, as a carrier for the antimicrobial agent and a filler for the polymeric matrix. The typical loading concentration of the antimicrobial organoclay is below 5 wt %. The new technology not only introduces antimicrobial properties into polymers, but also can enhance a wide range of engineering properties such as mechanical properties, barrier resistance, solvent attack and fire retardancy. Advantageously, the composites of the invention have been shown to be effective at preventing or inhibiting growth of both Gram-positive and Gram-negative bacteria without suffering the problem of biocide leaching. The nanocomposites are therefore more active and safer to use, and exhibit a wide range of improved physical and engineering properties.

The nanocomposites according to the invention have been shown to have antimicrobial properties. Preferably, the nanocomposites according to the invention are antibacterial composites. The bacterium, the growth of which may be inhibited or prevented by the composites, may be a Gram-positive or a Gram-negative bacterium. For example, bacteria against which the composites in accordance with the invention may be effective include Firmicutes, which may be Bacilli or Clostridia, for example Clostridium botulinum. In a preferred embodiment, bacteria against which the composites may be effective include Bacillales, preferably Staphylococcus. Preferably, a bacterium against which the composites may be effective is Staphylococcus aureus, as demonstrated in the Examples. It will be appreciated that S. aureus is the precursor of MRSA (ie Methicillin-resistant S. aureus).

Additional Bacillales against which the composites may be effective include Streptococci, for example, Streptococcus pyogenes or Streptococcus pneumoniae. Further examples of bacteria against which the composites in accordance with the invention may be effective include Pseudomonadales, preferably, Pseudomonas aeruginosa. Further examples of bacteria against which the composites may be effective include Gammaproteobacteria, which may be selected from a group consisting of Enterobacteriales, Proteus, Serratai, Pasteurellales, and Vibrionales. Enterobacteriales include Escherichia, for example Escherichia coli, as demonstrated in the Examples. Proteus includes Proteus mirabilis. Serratai include Serratia marcescens. Pasteurellales include Haemophilus influenzae. Vibrionales include Vibrio cholerae.

Further examples of bacteria against which the composites according to the invention may be effective include Betaproteobacteria, including Neisseriales, for example, Neisseria gonorrhoeae. Further examples of bacteria against which the composites may be effective include Delta/epsilon subdivided Proteobacteria, including Campylobacterales, for example Helicobacter pylori. Further examples of bacteria against which the composites may be effective include Actinobacteria, for example Mycobacterium tuberculosis and Nocardia asteroides.

The composites according to the invention may also be antiviral composites. The composites may be effective against any virus, and particularly an enveloped virus. Exemplary viruses are poxviruses, iridoviruses, togaviruses, or toroviruses, filovirus, arenavirus, bunyavirus, or a rhabdovirus, paramyxovirus or an orthomyxovirus, hepadnavirus, coronavirus, flavivirus, or a retrovirus, a herpesvirus or a lentivirus.

The composites according to the invention may be antifungal composites. For example, fungi against which the composites in accordance with the invention may be effective include a filamentous fungus, eg an Ascomycete. Furthermore, examples of fungi against which the composites in accordance with the invention may be effective are selected from a group of genera consisting of Aspergillus; Blumeria; Candida; Cryptococcus; Encephalitozoon; Fusarium; Leptosphaeria; Magnaporthe; Phytophthora; Plasmopara; Pneumocystis; Pyricularia; Pythium; Puccinia; Rhizoctonia; Richophyton; and Ustilago. The fungus may be selected from a group of species consisting of Aspergillus flavus; Aspergillus fumigatus; Aspergillus nidulans; Aspergillus niger; Aspergillus parasiticus; Aspergillus terreus; Blumeria graminis; Candida albicans; Candida cruzei ; Candida glabrata; Candida parapsilosis; Candida tropicalis; Cryptococcus neoformans; Encephalitozoon cuniculi; Fusarium solani; Leptosphaerianodorum; Magnaporthe grisea; Phytophthora capsici; Phytophthora infestans; Plasmopara viticola; Pneumocystis jiroveci; Puccinia coronata; Pucciniagraminis; Pyricularia oryzae; Pythium ultimum; Rhizoctonia solani; Trichophytoninterdigitale; TrichopAsyton rubrum; and Ustilago maydis. Further examples of fungi include yeast, such as Saccharomyces spp, eg S. cerevisiae, or Candida spp, eg C. albicans, which is known to infect humans.

In a most preferred embodiment, the nanocomposites of the invention have been shown to be effective at preventing or inhibiting growth of both Gram-positive (Staphylococcus aureus) and Gram-negative (Escherichia coli) bacteria. Since clay/polymer nanotechnology has been proved to be an effective way to enhance a wide range of physical and engineering properties of polymers, the inventors believe that the method and nanocomposites of the invention will enable the development of low-cost antimicrobial polymers with enhanced physical and engineering properties. Given the wide range of microorganisms that may be combated with the composites according to the invention, the inventors believe that the composites can be applied to a wide range of domestic, health care, packaging and engineering applications in which microbial infection is a problem.

The nanocomposites according to the invention may be put to numerous antimicrobial uses.

Therefore, in a further aspect of the invention there is provided a method of preventing or inhibiting microbial infection of an object, which method comprises forming the object in, or coating a surface thereof with, a polymer nanocomposite comprising an organoclay dispersed in a polymeric matrix, wherein the organoclay comprises a polymeric antimicrobial agent.

For instance, the nanocomposites may be used to coat surfaces and objects to prevent microbial infections or contamination. Hospital “superbugs” are one of the major problems in the health system, and antimicrobial products could be an effective solution to overcome the problem. The nanocomposites of the invention have been shown to be effective in the prevention of growth of Gram-positive bacteria, such as S. aureus, which is the precursor of MRSA. The technology can be applied to nylon and polyester fibres, which can be used to make patient clothing, and bedding products. Other applications could be medical equipment, furniture, electrical and electronic products, window frames and indoor decoration materials.

In another aspect of the invention, there is provided an object comprising a polymer nanocomposite comprising an organoclay dispersed in a polymeric matrix, wherein the organoclay comprises a polymeric antimicrobial agent.

The object may be formed of, or coated with, the nanocomposite. Preferably, the amount of nanocomposite that is used is sufficient to be effective for killing or preventing growth of microorganisms. It will be appreciated that the composites of the invention may be particularly useful for coating surfaces or objects that are required to be aseptic. As discussed above, the composites have the advantage that they are antimicrobial. Furthermore, as discussed in more detail below, the composites may be used to coat an object or a surface thereof, or to form an object directly therefrom, for example by moulding. The object may be screw-extruded, or rotation moulded, or injection moulded. Techniques suitable for coating an object with the nanocomposite are also well-known to those skilled in the art, and may include spraying the surface of the object with a liquid form of the nanocomposite and allowing the liquid to solidify to thereby leave a coating on the object.

The composites may be used to form an object by moulding, or to coat any object or device used in a biological or medical situation or environment, for which it may be important to prevent microbial infection or contamination that may lead to infection in a patient. The object may be a medical device. Examples of medical devices that may be coated or moulded using the composites of the invention include catheters, stents, wound dressings, contraceptive devices, surgical implants and replacement joints, contact lenses etc. The composites are particularly useful for coating biomaterials and objects and devices made therefrom. Microbial contamination/infection of biomaterials can be particularly problematic because the microorganism may use such material as a substrate for growth. For example, biomaterials (eg collagens and other biological polymers) may be used to cover the surface of artificial joints.

The composites may be used to coat surfaces in environments that are required to be aseptic. For instance, the composites may be used in medical environments. The composites may be used to keep hospital wards clean, and so almost any parts of a hospital ward may be coated with or formed from the composites of the invention. The composites may be used to prevent infection on surfaces of equipment (eg operating tables) in operating theatres as well as theatre walls and floors, and so these may be coated with or formed from the composites of the invention.

The nanocomposites of the invention may also be used to produce a wide range of domestic products, which may be prone to microbial infection. The product may be coated with or formed of the composite, and may be any of a wide range of different product types, eg a kitchen chopping board, a toilet seat or a carpet. Carpets are normally made from nylon, polyester and polypropylene fibres, which could simply be modified with the nanocomposite of the invention. However, it will be appreciated that the potential applications are much wider and the above list of objects and surfaces to which the composites according to the invention may be applied is not exhaustive. Hence, the composite may be applied to any surface prone to microbial infection or contamination, for example kitchen and bathroom surfaces and products.

The nanocomposites of the invention may also be useful in the manufacture of consumer items, particularly those that are handled in use, eg portable electronic devices such as mobile telephones and personal audio players, and computer peripherals, eg a keyboard or mouse.

The nanocomposites of the invention may be used in the manufacture of antimicrobial textiles or fabrics, which may be used to make bedding, and also in the clothing and fashion sectors.

Accordingly, in another aspect, there is provided a textile that comprises a polymer nanocomposite comprising an organoclay dispersed in a polymeric matrix, wherein the organoclay comprises a polymeric antimicrobial agent.

The textile may have applications, for example, in bedding used in hospitals and operating theatres, eg pillow covers, bed sheets, and duvet covers. The textile may be used in the manufacture of clothing, for example clothing prone to microbial infection, such as underwear and footwear.

Therefore, in another aspect, there is provided a clothing article comprising a textile that comprises a polymer nanocomposite comprising an organoclay dispersed in a polymeric matrix, wherein the organoclay comprises a polymeric antimicrobial agent.

The clothing article may be an article of underwear. The clothing article may be footwear. The antimicrobial nanocomposites may also be used in defence applications. Soldiers, particularly those in combat, are unable to wash frequently, and are therefore prone to microbial infection. Furthermore, clay/polymer nanocomposites are known to exhibit excellent fire retardancy characteristics. The combination of antimicrobial properties and fire retardancy make the use of nanocomposites of the invention ideal for application in military uniforms. Hence, the clothing article may be a uniform, eg a military uniform.

In addition, the excellent barrier properties and antimicrobial function in the nanocomposites of the invention make them suitable for food packaging.

Hence, in a further aspect of the invention, there is provided a packaging material comprising a polymer nanocomposite, which nanocomposite comprises a polymer nanocomposite comprising an organoclay dispersed in a polymeric matrix, wherein the organoclay comprises a polymeric antimicrobial agent.

Preferably, the packaging material is used for the packaging of perishable products, ie any product having limited lifespan or one which is at risk of microbial infection. Preferably, the packaging material is used for packaging a food product. For example, the packaging material may be used to package meat, bread, biscuits or vegetables.

All of the features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention, and to show how embodiments of the same may be carried into effect, reference will now be made, by way of example, to the following Examples and accompanying diagrammatic drawings, in which:

FIG. 1 shows a schematic illustration of the method according to the invention of using modified clay/polymer nanocomposite nanotechnology to produce antimicrobial polymer nanocomposites;

FIG. 2 shows the molecular structures of the two polymeric antimicrobial agents or biocides: (a) partially aminated polyvinylbenzylchloride (pVBzCl); and (b) quaternised vinylpyridine-co-styrene (qVP-co-St);

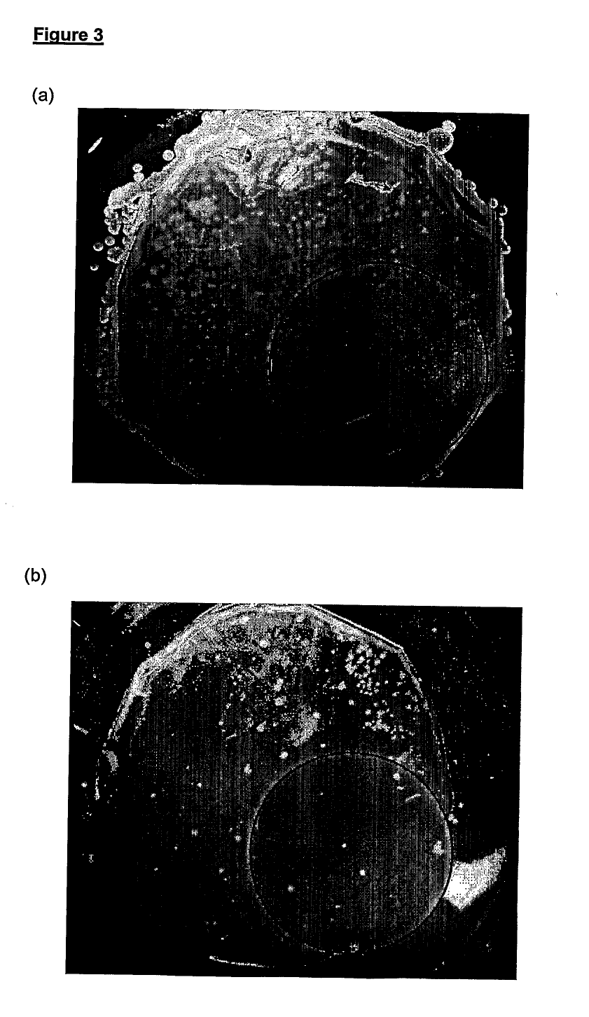

FIG. 3 shows growth plates indicating the appearance of (a) a plate of pristine polysulphone; and (b) a plate of its nanocomposite containing 10 wt % pVBzCl modified organoclay following a bacterial growth test with E. coli;

FIG. 4 shows the growth of S. aureus on (1) a control plate of nylon-6 and (2) a plate of a clay/nylon-6 nanocomposite modified using pVBzCI polymeric biocide with 5wt % clay content; and

FIG. 5 is a graph demonstrating leaching of ionic non-polymeric antimicrobial agents from Nylon-6 nanocomposites.

### EXAMPLE 1

### Synthesis of Aminated pVBzCl

40 g of polyvinylbenzylchloride (pVBzCI) (molecular weight 55,000) was dissolved in 500 ml of THF to produce a polymer solution. 26.5 ml (78.6 mmol) of N,N-dimethylhexadecylamine was added to the polymer solution. This makes the molar ratio of vinylbenzyl chloride units to tertiary amine 3:1. The reaction in the mixture was carried out at 60° C. for 24 hours under constant stirring. After the reaction, polymer product was not isolated from the solution, but was used directly for clay modification.

### EXAMPLE 2

### Synthesis of gVP-co-St

20 g of poly(4-vinylpyridine-co-styrene) (molecular weight 400,000; 10 mol % styrene) was dissolved in 200 ml of dimethylformamide (DMF) to produce a copolymer solution. 60 ml (0.25 mol) of 1-bromododecane was added to the solution. The reaction in the mixture was carried out at 80° C. for 24 hours under constant stirring. After the reaction, polymer product was not isolated from the solution, but was used directly for clay modification.

### EXAMPLE 3

### Clay Modification

4 g of Na-montmorillonite was added into 250 ml of distilled water to produce a clay suspension. The suspension was stirred at ambient temperature overnight. The organoclay for each polymer biocide was produced by dilution of 25 g biocide solution using 200 ml of THF. Clay suspension was slowly added to the diluted polymer solution with constant stirring. A further 50 ml of water was added into the reaction mixture afterwards. The reaction mixture was stirred at ambient temperature for 24 hours and followed by repeated centrifugation and washing with 50/50 water/THF mixture three times to obtain PVBzCl or qVP-co-St modified organoclays.

### EXAMPLE 4

### Clay Modification

8 g of Na-montmorillonite (commercial name Cloisite Na+) was added into 250 ml of distilled water to produce a clay suspension. The suspension was stirred at ambient temperature overnight. 40 g of the biocidal polymer solution (prepared in Example 1 or Example 2) was diluted to 200 ml using THF. The clay suspension was slowly added to the diluted polymer solution with constant stirring. A further 50 ml of water was added into the reaction mixture afterwards. The reaction mixture was stirred at ambient temperature for 24 hours and followed by repeated centrifugation and washing with 50/50 water/THF mixture three times with pure water before freeze-drying the organoclay. The biocidal organoclays prepared contained 33 wt % of the biocidal polymer.

### EXAMPLE 5

### Formation of Nanocomposites by Solvent-Assisted Dispersion

Referring to FIG. 1, there is shown a schematic process for preparing antimicrobial nanocomposites. The method was used to prepare the various embodiments of antimicrobial nanocomposite according to the invention and involves the following steps:
1) intercalating a polymeric antimicrobial agent (1) into a clay (2) to form an organoclay (3); and
2) dispersing the organoclay (3) into a suitable polymer (4) to form the antimicrobial nanocomposite material (5).

Step (2) may be carried out by various methods, including (i) melt compounding (see, for instance, Vaia, R A, Ishii, H & Giannelis, E P, Synthesis and properties of two-dimensional nanostructures by direct intercalation of polymer melts in layered silicates, Chem Mater, 5, 1694-1696 (1993)); (ii) in situ polymerization (see, for instance, Okada, A, Kawasumi, M, Usuki, A, Kojima, Y, Kurauchi, T & Kamigaito, O, Nylon 6-clay hybrid, Mater Res Soc Proc, 171, 45-50 (1990)); or (iii) solvent-assisted dispersion (see, for instance, Yano, K, Usuki, A, Okada, A, Kurauchi, T & Kamigaito, O, Synthesis and properties of polyimide-clay hybrid, J Polym, Sci, Part A: Polym Chem, 31, 2493-2498 (1993)).

Smectite clay has net negative charge on the surface of each layer due to some of the aluminium cations Al³⁺ in its octagonal structure being substituted by lower valency cations, such as Mg²⁺ and Ca²⁺. The negatively charged clay surface therefore allows the antimicrobial agent in either cation or Lewis acid form to intercalate into the space between the clay layers in step (1) of the method. This causes layer expansion and changes the surface properties of the clay from hydrophilic to organophilic. The organoclay thus formed is compatible with hydrophobic polymers. Therefore, it is possible to exfoliate those individual clay layers with attached antimicrobial agents into a polymer matrix to achieve uniform dispersion and to allow antimicrobial molecules to be exposed to the external surface, producing the nanocomposite material.

The process of dispersing the clay-biocide compound in to the polymeric matrix is shown in FIG. 1, and was carried out in dimethylacetamide (DMMA) by applying a solvent-assisted intercalation/exfoliation method to produce two types of clay/polysulphone nanocomposite with 10 wt % content of each corresponding organoclay.

10 g of polysulfone and 1 g organoclay (prepared in accordance with Example 3) were added into dimethylacetamide (DMAA). The mixture was stirred for 24 hours to provide uniform dispersion. The mixture for casting was required to be stable without any signs of clay precipitation for 1 week. After that, the mixture was cast into a layer of 100 μm thick film on a glass plate using a sliding mould. The plate was dried at a temperature of 110° C. under vacuum to obtain dried nanocomposite film.

### EXAMPLE 6

### Microbiology Test of the Nanocomposites

Nanocomposite films (prepared in accordance with Example 5) were immersed in 40 ml of an E. coli or S. aureus suspension containing 10⁶ CFU/ml of cells. The samples were kept in the bacterial suspension for 24 hours at 37° C. After incubation, the samples were dried at room temperature and placed in Petri dishes with application of a layer of solid growth agar to cover the samples immediately. Control polysulfone samples were prepared using the same procedure. The bacterial colony growth on the polymer surface was counted as cell viability in percentage of viable cells in comparison with the control sample.

Nanocomposites moulded into square plates were also tested against E. coli or S. aureus using a modified method. Bacterial suspension containing 10⁶ CFU/ml of cells was finely sprayed onto a plate in a fume hood using a 10 ml thin layer chromatography sprayer. The plate covered with cell suspension was dried for 3 hours at 37° C. Similarly, control samples of polymers which did not contain organoclay were treated with bacterial suspension. After drying, control and tested samples were placed on a solid growth agar in a Petri dish with the sides covered with bacterial layer faced growth agar. The plates were kept on agar for 3 hours at 37° C. After that, plates were removed from the agar, leaving cells on the agar surface. Petri dishes were incubated for 24 hours at 37° C. The bacterial colony growth on the polymer surfaces was graded as: (+++)—intensive bacterial growth; (+)—isolated colonies; (−)—no growth.

The antimicrobial properties of the two nanocomposites were characterised by observing the growth of S. aureus and E. coli on casting nanocomposite films in comparison with the control samples of the pure or pristine polysulfone film, and the results are shown in FIGS. 3a and 3b, and in Table 1.

FIG. 3a shows E. coli bacterial growth on the original polysulfone film, and FIG. 3b shows the extent of bacterial growth on the nanocomposite film containing 10 wt % organoclay modified by the pVBzCI polymeric surfactant. It can be seen that bacteria could not grow in the nanocomposites shown in FIG. 3b, whereas a significant amount of bacterial growth can be observed in the pristine polymer in FIG. 3a.

Quantitative data on the nanocomposites against both E. coli and S. aureus were obtained using the same experimental method. In this case, the cell viability was measured as the percentage of viable cells in comparison with the original polymer. The data is shown in Table 1. The antimicrobial behaviour becomes significant when the content of organoclay in the composites is as low as 2.5 wt %, approximately 50% reduction in bacteria growth being observed. At 10 wt % loading of organoclay, the composites produced from both pVBzCI and qVP-co-St can prevent bacterial development effectively.

Table 1 shows the cell viability expressed as the percentage of viable cells in comparison with the control sample following immersion of the samples in E. coli and S. aureis suspensions containing 10⁶ CFU/ml of cells for 24 hours at 37° C. The corresponding images of the pristine polysulfone and its nanocomposite with 10 wt %/pVBzCl modified organoclay following the microbiology experiment with E. coli are shown in FIG. 3.

TABLE 1

| | Aminated pVBzCl | | | qVP-co-St |
|---|---|---|---|---|
| | Organoclay content, wt. % | | | |
| | 2.5 | 5 | 10 | 10 |
| Escherichia coli | 50 ± 10 | 60 ± 10 | 90 ± 5 | 97 ± 2 |
| Staphylococcus aureus | 40 ± 10 | 50 ± 10 | 80 ± 5 | 95 ± 5 |

The data demonstrate that both nanocomposites are able to significantly inhibit the growth of S. aureus and E. coli. The nanocomposites are slightly more effective at inhibiting the growth of Gram-negative bacteria (E. coli) than Gram-positive bacteria (S. aureus). The composite produced from qVP-co-St modified organoclay is superior to the composite produced from pVBzCI organoclay in inhibiting growth of both types of bacteria.

### EXAMPLE 7

### Nanocomposite Preparation by Melt Processing

Nylon-6/clay nanocomposites were produced using a 16 mm twin-screw extruder with operating conditions of L/D ratio 24/1, temperature 240° C., screw speed 400 rpm and feeding rate 25%. Before extrusion, nylon-6 with the commercial name BASF B3 and organoclay (prepared in accordance with Example 4) were pre-dried and blended. The final clay content in the nanocomposites was 5 wt % based on the content of Cloisite Na⁺. The nanocomposite pellets produced were further processed using injection moulding to produce square-plate samples with dimension 25 mm×25 mm×1 mm for microbiological testing.

### EXAMPLE 8

### Microbiological Testing

Procedure: Antimicrobial activity was determined against Gram-negative (Escherichia coli BE, P. aeruginoa CCM 1961) and Gram-positive (Staphylococcus aureis CCM 209). Bacteria cultures were purchased from Ukrainian Collections of Microorganism.

Freshly harvested bacteria were used for the test. 400 μl of bacterial suspensions containing −10⁶ cell/ml were applied to the surface of polymer specimens of dimensions 25×25 mm. The polymer sample was immediately covered with another specimen, applying some pressure in order to evenly distribute the suspension through the polymer surfaces. Such an assembly of two polymer pieces was kept at 30° C. for 24 h. After that, polymer samples were separated and laid into solid nutrient medium by the side covered with bacteria. In 40 minutes, polymer samples were removed, leaving bacterial cells on the surface of solid agar. Petri dishes with agar seeded in such way were incubated at 30° C. for 24 h. After incubation, plates were checked for bacterial growth.

FIG. 4 shows the image of bacteria growth against S. aureus on both control and the nanocomposites with organoclay modified using pVBzCI polymeric biocide with 5 wt % clay content following the microbiological test. The bacteria colonies are not visible on the nanocomposite samples. The quantitative data of the samples against S. aureus, E. coli and Pseudomonas aeruginosa is given in Table 2. In the Table, the bacterial colony growth on the polymer surfaces was graded as: (++++) very extensive bacteria growth, (+++)—intensive bacterial growth; (+)—isolated colonies; (−)—no growth. It can be seen that extensive growth of bacteria occurred on the surface of the original nylon-6 samples. However few visible bacteria colonies can be observed on the surface of the nanocomposite samples. In other words, the antimicrobial clay/polymer nanocomposites made from pVBzCI-modified clay are effective in inhibiting development of all these three types of bacteria.

TABLE 2

| | Control | Composite |
|---|---|---|
| S. aureus | ++++ | − |
| E. coli | ++++ | − |
| P. aeruginosa | ++++ | − |

### EXAMPLE 9

### Tensile Yield Strength Testing

The tensile yield strength of the composite together with the original nylon-6 was tested using a tensile loading machine. The samples were made using injection moulding with sample geometry specified by ASTM 1708-06a. The cross-head speed applied was 15 mm/min. Five samples were tested for each type of material. The data are shown in Table 3. Compared to the original nylon-6, there are 45% and 38% improvements in tensile yielding strength for the nanocomposites with 5 wt % clay loading produced from pVBzCI and qVP-co-St respectively.

TABLE 3

| | Tensile yielding |
|---|---|
| Materials | strength, MPa |
| Nylon-6 | 50.4 ± 2.4 |
| Nylon-6 nanocomposite made from pVBzCl modified | 72.9 ± 1.5 |
| clay with 5 wt % clay content | |
| Nylon-6 nanocomposite made from qVP-co-St | 69.5 ± 1.1 |
| modified clay with 5 wt % clay content | |

### EXAMPLE 10

### Leaching Test

Two pieces of polymer plates with dimension 20×20×1 mm were immersed into 20 ml of distilled water in a tube. The system was maintained at ambient temperature for up to two months. The electrical conductivity of the water in the tube was measured periodically using a CDM210 Conductivity Meter produced by Radiometer Analytical, France, equipped with CDC 745 conductivity cells.

Referring to FIG. 5, there is shown the electrical conductivity of leached onium cations from nanocomposites in water following a two-month experiment. The five different nanocomposites shown in the legend were produced from nylon-6 and 5 wt % Cloisite 10A, 15A, 20A, 30B and 93A commercial organoclays, ie organoclays containing non-polymeric quaternary ammonium salts. The conductivity of the solutions is a measure of the concentration of leached oniums from each corresponding composite. From FIG. 5, it can be seen that the conductivity of the water increases with time for each composite tested. This is an indication of onium leaching from the nanocomposites.

Similar tests conducted using nanocomposites produced in accordance with Example 7, using the polymeric antimicrobial agents of Examples 1 and 2, showed that there was little change in the conductivity of the water following one month of immersion of the composites in water. This indicates that the polymeric biocides in the nanocomposites do not leach out into the aqueous surroundings.

1. A method of preparing a polymer nanocomposite having antimicrobial properties, the method comprising:
(i) contacting a polymeric antimicrobial agent with a clay to form an organoclay; and
(ii) subsequently dispersing the organoclay in a polymeric matrix.

2. A method according to claim 1, wherein the clay is selected from a group of clay types including smectite, illite and chlorite.

3. A method according to claim 2 wherein the clay comprises smectite.

4. A method according to claim 1, wherein the clay comprises montmorillonite, bentonite, nontronite, beidellite, volkonskoite, hectorite, saponite, stevensite, sauconite, sobockite or svinfordite.

5. (canceled)

6. (canceled)

7. A method according to claim 1, wherein the polymeric antimicrobial agent is cationic.

8. (canceled)

9. A method according to claim 1, wherein the polymeric antimicrobial agent comprises an onium group.

10. (canceled)

11. A method according to claim 1, wherein the polymeric antimicrobial agent comprises a quaternary onium group.

12.-13. (canceled)

14. A method according to claim 11, wherein the polymeric antimicrobial agent is represented by formula I: 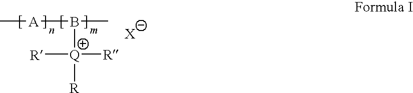
in which
n and m are independently between 2 and 500;
the groups A, which may be the same or different, are monomer residues of a first form;
the groups B, which may be the same or different, are monomer residues of a second form;
the group Q^{⊕}, is a nitrogen or phosphorous atom;
R, R′ and R″ independently represent hydrogen or an optionally substituted alkyl or aryl group; and
X⁻ is a counterion.

15. A method according to claim 11, wherein the polymeric antimicrobial agent is represented by formula II: 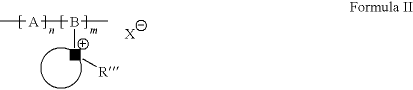
in which
n and m are independently between 2 and 500;
the groups A, which may be the same or different, are monomer residues of a first form;
the groups B, which may be the same or different, are monomer residues of a second form; 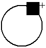
is a quaternary nitrogen-containing heterocycle;
R″′ represents hydrogen or an optionally substituted alkyl group; and
X⁻ is a counterion.

16. A method according to claim 15, wherein monomer residues (A) and (B) independently include optionally substituted alkylene groups.

17. A method according to claim 16, wherein (A) and (B) independently represent optionally substituted ethylene groups.

18. A method according to claim 15, wherein R, R′, R″ and/or R″′ represents a C₁-C₃₀ alkyl group.

19.-21. (canceled)

22. A method according to claim 15, wherein the polymeric antimicrobial agent comprises partially aminated polyvinylbenzylchloride (pVBzCl) or quaternised vinylpyridine-co-styrene (qVP-co-St).

23. (canceled)

24. A method according to claim 1, wherein the polymer matrix is selected from a group consisting of polyethylene; polypropylene; polystyrene; polyvinylchloride; polyamide (nylon); polyethyleneterephthalate; polybutyleneterephthalate; polymethylmethacrylate; polycarbonate; polyurethane; epoxy; polycaprolactone; polyvinylalcohol; acrylonitrile-butadiene-styrene; polyacrylonitrile; ethylene-vinylacetate; rubber; vulcanized rubber; polyimide; polyisoprene; polydimethylsiloxane; polysulphone; polyurethane; polyetheretherketone; polytetrafluoroethylene; polyvinylidenechloride; polyvinylidenefluoride; polyoxymethylene; polyethersulfone; poly(p-phenylene oxide); poly(p-phenylene sulfide); thermosetting polyesters; and cyanoacrylates.

25. A method according to claim 1, wherein the polymer matrix is polyamide or polysulphone.

26. A method according to claim 1, wherein the polymer nanocomposite comprises between about 0.1 and 30 wt % of organoclay modified with polymeric biocide.

27. (canceled)

28. An antimicrobial polymer nanocomposite comprising a clay, a polymeric antimicrobial agent, and a polymeric matrix.

29. A method of preventing or inhibiting microbial infection of an object, which method comprises forming the object in, or coating a surface thereof with, a polymer nanocomposite comprising an organoclay dispersed in a polymeric matrix, wherein the organoclay comprises a polymeric antimicrobial agent.

30.-38. (canceled)

39. A polymeric antimicrobial agent represented by formula I: 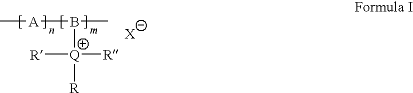
in which
n and m are independently between 2 and 500;
the groups A, which may be the same or different, are monomer residues of a first form;
the groups B, which may be the same or different, are monomer residues of a second form;
the group Q⊕, is a nitrogen or phosphorous atom;
R, R′ and R″ independently represent hydrogen or an optionally substituted alkyl or aryl group; and
X⁻ is a counterion.

40. A polymeric antimicrobial agent represented by formula II: 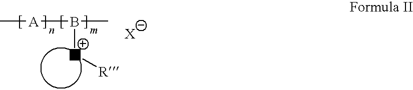
in which
n and m are independently between 2 and 500;
the groups A, which may be the same or different, are monomer residues of a first form;
the groups B, which may be the same or different, are monomer residues of a second form; 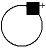
is a quaternary nitrogen-containing heterocycle;
R″′ represents hydrogen or an optionally substituted alkyl group; and
X⁻ is a counterion.

41. An organoclay comprising clay having intercalated therewith a polymeric antimicrobial agent.

42.-43. (canceled)

44. A method according to claim 14, wherein monomer residues (A) and (B) independently include optionally substituted alkylene groups.

45. A method according to claim 44, wherein (A) and (B) independently represent optionally substituted ethylene groups.

46. A method according to claim 14, wherein R, R′, R″ and/or R″′ represents a C₁-C₃₀ alkyl group.

47. A method according to claim 14, wherein the polymeric antimicrobial agent comprises partially aminated polyvinylbenzylchloride (pVBzCI) or quaternised vinylpyridine-co-styrene (qVP-co-St).
